(19) United States
(12) Patent Application Publication
(10) Pub. No.: US 2026/0238725 A1
(43) Pub. Date: Aug. 13, 2026

(54) SUPPORT SYSTEM AND SUPPORT METHOD

(71) Applicant: Hiroaki KOUNO, Osaka (JP)

(72) Inventor: Hiroaki KOUNO, Osaka (JP)

(21) Appl. No.: 19/161,244

(22) PCT Filed: Nov. 24, 2023
(86) PCT No.: PCT/JP2023/042260

§ 371 Date: Aug. 30, 2025

(30) Foreign Application Priority Data
Mar. 5, 2023 (JP) 2023-033274
Mar. 10, 2023 (JP) 2023-037425
Jul. 11, 2023 (JP) 2023-114021

(51) Int. Cl. H04M 3/51; H04M 3/523

(52) U.S. Cl. CPC H04M 3/5191; H04M 3/5233; H04M 2201/38

(57) ABSTRACT

A support system 100 in one aspect of the present invention includes: a server 50 that includes storage means for storing first information relating to a support recipient who requests support from a supporter, or includes the storage means and transmission means for transmitting the first information; a transmission information generation unit 51; and an information transmission unit 52. When the first information has been input to an input form provided by the server 50, from a first terminal 10 that is available to the support recipient, the support system 100 enters into the state (a) or (b) described below: (a) a state in which transmission information that includes the first information is stored by the storage means of the server 50, and the first information that has been stored by the storage means by using information transmission means 70 is viewable by using a second terminal that is communicably connected to the server 50 via the information transmission means, and is available to the supporter; and (b) a state in which the first information that has been transmitted by the transmission means of the server 50 is viewable by using the second terminal 20 that is capable of receiving the first information, the transmission information generation unit 51 generates the transmission information that includes the first information including an indication or sound that distinguishes between a first support recipient including the introducer information and a second support recipient not including the introducer information, only the first information relating to the first support recipient including the introducer information, or only the first information relating to the second support recipient not including the introducer information, and the information transmission unit 52 transmits the transmission information to the second terminal 20.

### TECHNICAL FIELD

The present invention relates to a support system and a support method.

### BACKGROUND ART

In circumstances where society has become more complicated, and compliance has also been required, it can be said that there has been an increasing need to consult with various experts in a variety of life situations and business situations. However, not a few people have a hard time deciding the appropriate time, person, and way to contact. On the other hand, as a result of the spread of the Internet and a recent trend of digital transformation (DX), a large amount of information can be easily transmitted, if a social infrastructure (what is called an information infrastructure) that supports the distribution of information, or the like, and a digital communication terminal are used.

Therefore, in modern times, in a case where a natural person (an individual), a juridical person, or an organization without juridical personality wishes to seek advice or an answer to a question that would fail to be solved by only independently conducting research by utilizing libraries or the Internet (for example, a question about a professional matter), it is possible to ask the question to many experts at a time.

Note that, as a conventional technique, there are disclosed a counselor support method for providing answer content on the basis of index information that corresponds to at least one keyword relating to counseling in the past (whether there is relevance to counseling history and the counseling history of a counselor), and the computing device thereof (Patent Document 1). In addition, there is disclosed an expert search apparatus that is communicable with a client terminal to be used by a client and an expert terminal to be used by an expert, and is configured to search for an expert with whom the client wishes to consult from among registered experts, the expert search apparatus including: expert information storage means for storing at least a name and an address (a region) of the expert, a qualification possessed by the expert, and a consultation content category that can be handled; search processing means for causing the client terminal to display, to the client, a search screen that displays, in one screen, the region and the consultation content category of the expert with whom the client wishes to consult, and searching the expert information storage means to display a list of experts who belong to the region selected by the client and for whom the consultation content category has been registered; and transmission/reception processing means for displaying a consultation content input screen to which consultation content is to be input to an expert selected by the client from the list of experts, and transmitting, to the expert terminal, the consultation content that has been input (Patent Document 2).

### Prior Art Documents

### Patent Documents

Patent Document 1: Japanese Patent Laid-open Publication No. 2022-068807
Patent Document 2: Japanese Patent Laid-open Publication No. 2013-097493

### SUMMARY OF THE INVENTION

### Problems to be Solved by the Invention

However, in a case where consultation has been simultaneously requested by a plurality of clients, which client an expert (a supporter) who wishes to support the clients will provide consultation to with priority is determined depending on individual circumstances in many cases. Therefore, there have been no rules for the order of providing consultation. In addition, none of the patent documents described above disclose or suggest a problem as to which client an expert (a supporter) who wishes to support a plurality of clients will provide consultation to with priority.

### Solutions to the Problems

The present invention can significantly contribute to a reduction in a work burden of giving a “priority order”, which is very troublesome for a supporter (typically, an expert) who has received a plurality of consultation requests simultaneously or during the same period, as described above.

Natural persons (individuals), juridical persons, or organizations without juridical personality (hereinafter also collectively referred to as “support recipients”) who wish to consult with a supporter (typically, an expert) greatly vary in age, a region, and circumstances, and the time and effort to be predicted for support are unknown. Therefore, it is not easy to appropriately and clearly categorize pieces of content of individual specific questions, and then determine priority orders. In view of the above, the present invention has been created by focusing on the fact that the supporter can easily determine the priority orders, by roughly dividing the pieces of content of individual specific questions into two by focusing on a background of a support recipient's request for consultation.

A support system in one aspect of the present invention includes: a server that includes storage means for storing first information relating to a support recipient who requests support from a supporter, or includes the storage means and transmission means for transmitting the first information, the support recipient being one selected from a group of a natural person, a juridical person, and an organization without juridical personality; a first terminal that is communicably connected to the server via information transmission means, is available to the support recipient, and enables the first information to be input to an input form provided by the server; and a second terminal that is communicably connected to the server via the information transmission means, is available to the supporter, and enables the first information that has been stored by the storage means of the server by using the information transmission means to be viewed, or is capable of receiving the first information that has been transmitted by the transmission means. In addition, in the system, in a case where the first information includes introducer information relating to an introducer having a predetermined attribute, a display unit that is connected to the server and/or the second terminal displays a first support recipient having the first information including the introducer information and a second support recipient having the first information not including the introducer information in a mutually distinguished manner, or a sound generation unit included in the server and/or the second terminal emits different sound, while distinguishing between the first support recipient and the second support recipient.

From a different point of view of the support system in the one aspect of the present invention, the support system includes a server that includes storage means for storing first information relating to a support recipient who requests support from a supporter, or includes the storage means and transmission means for transmitting the first information, the support recipient being one selected from a group of a natural person, a juridical person, and an organization without juridical personality, when the first information has been input to an input form provided by the server, from a first terminal that is communicably connected to the server via information transmission means, and is available to the support recipient, the support system enters into the state (a) or (b) described below:
(a) a state in which transmission information that includes the first information is stored by the storage means of the server, and the first information that has been stored by the storage means by using the information transmission means is viewable by using a second terminal that is communicably connected to the server via the information transmission means, and is available to the supporter; and
(b) a state in which the first information that has been transmitted by the transmission means of the server is viewable by using the second terminal that is capable of receiving the first information, and
the support system includes:
a display unit that is connected to the server and/or the second terminal that, in a case where the first information includes introducer information relating to an introducer having a predetermined attribute, displays a first support recipient having the first information including the introducer information and a second support recipient having the first information not including the introducer information, in a mutually distinguished manner; or
a sound generation unit that is included in the server and/or the second terminal, and that, in a case where the first information includes the introducer information relating to the introducer having the predetermined attribute, emits different sound, while distinguishing between the first support recipient having the first information including the introducer information and the second support recipient having the first information not including the introducer information.

According to each of the support systems described above, a support recipient that has been introduced by an introducer having a predetermined attribute (the first support recipient) is distinguished from a support recipient that has not been introduced (the second support recipient), and therefore a supporter can easily determine a “priority order” when the supporter provides support. As a result, the supporter can reduce a time or mental work burden of giving the “priority order”, and therefore the supporter can focus time and effort on achieving further enhanced support to the support recipient.

Furthermore, a support system in another aspect of the present invention includes: a server that includes storage means for storing first information relating to a support recipient who requests support from a supporter, or includes the storage means and transmission means for transmitting the first information, the support recipient being one selected from a group of a natural person, a juridical person, and an organization without juridical personality; a first terminal that is communicably connected to the server via information transmission means, is available to the support recipient, and enables the first information to be input to an input form provided by the server; and a second terminal that is communicably connected to the server via the information transmission means, is available to the supporter, and enables the first information that has been stored by the storage means of the server by using the information transmission means to be viewed, or is capable of receiving the first information that has been transmitted by the transmission means. In addition, this system includes: a transmission information generation unit that generates transmission information that includes the first information; and an information transmission unit that is capable of transmitting the transmission information, in a case where the first information includes introducer information relating to an introducer having a predetermined attribute, the transmission information generation unit generates the transmission information that includes the first information including an indication or sound that distinguishes between the first support recipient including the introducer information and the second support recipient not including the introducer information, only the first information relating to the first support recipient having the first information including the introducer information, or only the first information relating to the second support recipient having the first information not including the introducer information, and the information transmission unit transmits, to the second terminal, the transmission information that includes the first information including the indication or the sound that distinguishes between the first support recipient including the introducer information and the second support recipient not including the introducer information, only the first information relating to the first support recipient, or only the first information relating to the second support recipient.

From a different point of view of the support system in the other aspect of the present invention, the support system includes: a server that includes storage means for storing first information relating to a support recipient who requests support from a supporter, or includes the storage means and transmission means for transmitting the first information, the support recipient being one selected from a group of a natural person, a juridical person, and an organization without juridical personality; a transmission information generation unit that generates transmission information that includes the first information; and an information transmission unit that is capable of transmitting the transmission information, and
when the first information has been input to an input form provided by the server, from a first terminal that is communicably connected to the server via information transmission means, and is available to the support recipient, the support system enters into the state (a) or (b) described below:
(a) a state in which transmission information that includes the first information is stored by the storage means of the server, and the first information that has been stored by the storage means by using the information transmission means is viewable by using a second terminal that is communicably connected to the server via the information transmission means, and is available to the supporter; and
(b) a state in which the first information that has been transmitted by the transmission means of the server is viewable by using the second terminal that is able to receive the first information.

In addition, in this system,
in a case where the first information includes introducer information relating to an introducer having a predetermined attribute, the transmission information generation unit generates the transmission information that includes the first information including an indication or sound that distinguishes between the first support recipient including the introducer information and the second support recipient not including the introducer information, only the first information relating to the first support recipient having the first information including the introducer information, or only the first information relating to the second support recipient having the first information not including the introducer information, and
the information transmission unit transmits, to the second terminal, the transmission information that includes the first information including the indication or the sound that distinguishes between the first support recipient including the introducer information and the second support recipient not including the introducer information, only the first information relating to the first support recipient, or only the first information relating to the second support recipient.

According to each of the support systems described above, a support recipient that has been introduced by an introducer having a predetermined attribute (the first support recipient) can be distinguished from a support recipient that has not been introduced (the second support recipient). Specifically, the second terminal can receive the first information including the indication or the sound that distinguishes between the first support recipient including the introducer information and the second support recipient not including the introducer information, only the first information relating to the first support recipient, or only the first information relating to the second support recipient, and therefore the supporter of the second terminal can recognize the first support recipient and the second support recipient in a mutually distinguished manner. This can make it easy to determine the “priority order” when the supporter provides support. As a result, the supporter can reduce a time or mental work burden of giving the “priority order”, and therefore the supporter can focus time and effort on achieving further enhanced support to the support recipient.

A support method in one aspect of the present invention is performed by using a support system that includes: a server that includes storage means for storing first information relating to a support recipient who requests support from a supporter, and/or transmission means for transmitting the first information, the support recipient being one selected from a group of a natural person, a juridical person, and an organization without juridical personality; a first terminal that is communicably connected to the server via information transmission means, is available to the support recipient, and enables the first information to be input to an input form provided by the server; and a second terminal that is communicably connected to the server via the information transmission means, is available to the supporter, and enables the first information to be viewed or is capable of receiving the first information transmitted by the transmission means, and the support method includes: a display process in which, in a case where the first information includes introducer information related to an introducer having a predetermined attribute, a display unit that is connected to the server and/or the second terminal displays a first support recipient having the first information including the introducer information and a second support recipient having the first information not including the introducer information in a mutually distinguished manner; or a process in which a sound generation unit included in the server and/or the second terminal emits different sound, while distinguishing between the first support recipient and the second support recipient.

From a different point of view of the support method in the one aspect of the present invention, the support method is performed by using a support system including a server that includes storage means for storing first information relating to a support recipient who requests support from a supporter, or includes the storage means and transmission means for transmitting the first information, the support recipient being one selected from a group of a natural person, a juridical person, and an organization without juridical personality, and the support method includes: respective processes including (a), (b), and (c1) described below; respective processes including (a), (b), and (c2); respective processes including (a), (b), and (c3); or respective processes including (a), (b), and (c4). Note that (c1), (c2), (c3), or (c4) described above is performed after each process of (a) and (b) described above.
(a) A determination process in which, when the first information has been input to an input form provided by the server, from a first terminal that is communicably connected to the server via information transmission means, and is available to the support recipient, the server that has stored the first information, or a second terminal that is communicably connected to the server via the information transmission means, is available to the supporter, and enables the first information that has been stored by the storage means of the server by using the information transmission means to be viewed or is capable of receiving and storing the first information that has been transmitted by the transmission means determines whether the first information includes introducer information relating to an introducer of the support recipient, the introducer having a predetermined attribute
(b) A process in which the server or the second terminal distinguishes between a first support recipient having the first information including the introducer information and a second support recipient having the first information not including the introducer information
(c1) A display process in which, in a case where the first information includes the introducer information, the first support recipient and the second support recipient are displayed in a mutually distinguished manner in a display unit that is connected to the server, or
a process in which, in a case where the first information includes the introducer information, the server (as an example, a sound generation unit included in the server) emits different sound while distinguishing between the first support recipient and the second support recipient
(c2) A display process in which, in a case where the first information includes the introducer information, the first support recipient and the second support recipient that have been distinguished by the server are displayed in a mutually distinguished manner in the second terminal, by using the information transmission means, or
a process in which, in a case where the first information includes the introducer information, the second terminal emits different sound while distinguishing between the first support recipient and the second support recipient, by using the information transmission means
(c3) A display process in which, in a case where the first information includes the introducer information, the first support recipient and the second support recipient that have been distinguished by the second terminal are displayed in a mutually distinguished manner in the second terminal, without using the information transmission means, and in other words, without the need for being connected to the server by using the information transmission means, or
a process in which, in a case where the first information includes the introducer information, the second terminal emits different sound while distinguishing between the first support recipient and the second support recipient, without using the information transmission means, and in other words, without the need for being connected to the server by using the information transmission means
(c4) A display process in which, in a case where the first information includes the introducer information, the first support recipient and the second support recipient are displayed in a mutually distinguished manner in the second terminal, by using the transmission means of the server, or a process in which, in a case where the first information includes the introducer information, the second terminal emits different sound while distinguishing between the first support recipient and the second support recipient, by using the transmission means of the server.

Each of the support methods described above includes a display process of displaying a support recipient that has been introduced by an introducer having a predetermined attribute (the first support recipient) and a support recipient that has not been introduced (the second support recipient) in a mutually distinguished manner, or a process of emitting sound, and therefore a supporter can easily determine a “priority order” when the supporter provides support. As a result, the supporter can reduce a time or mental work burden of giving the “priority order”, and therefore the supporter can focus time and effort on achieving further enhanced support to the support recipient.

A support method in another aspect of the present invention is performed by a support system including: a server that includes storage means for storing first information relating to a support recipient who requests support from a supporter, and transmission means for transmitting the first information, the support recipient being one selected from a group of a natural person, a juridical person, and an organization without juridical personality; a first terminal that is communicably connected to the server via information transmission means, and enables the support recipient to use the storage means for storing and the transmission means for transmitting the first information, and to input the first information to an input form provided by the server; and a second terminal that is communicably connected to the server via the information transmission means, is available to the supporter, and enables the first information to be viewed or is capable of receiving the first information transmitted by the transmission means, the support method includes: a transmission information generation process of generating transmission information that includes the first information; and an information transmission process that enables the transmission information to be transmitted, in the transmission information generation process, in a case where the first information includes introducer information relating to an introducer having a predetermined attribute, the transmission information that includes the first information including an indication or sound that distinguishes between a first support recipient including the introducer information and a second support recipient not including the introducer information, only the first information relating to the first support recipient having the first information including the introducer information, or only the first information relating to the second support recipient having the first information not including the introducer information, is generated, and in the information transmission process, the transmission information that includes the first information including the indication or the sound that distinguishes between the first support recipient including the introducer information and the second support recipient not including the introducer information, only the first information relating to the first support recipient, or only the first information relating to the second support recipient, is transmitted to the second terminal.

From a different point of view of the support method in the other aspect of the present invention, the support method is performed by using a support system including a server that includes storage means for storing first information relating to a support recipient who requests support from a supporter, and transmission means for transmitting the first information, the support recipient being one selected from a group of a natural person, a juridical person, and an organization without juridical personality, and the support method includes: a transmission information generation process in which, when the first information has been input to an input form provided by the server, from a first terminal that is communicably connected to the server via information transmission means, and is available to the support recipient, transmission information that includes the first information is generated; and an information transmission process in which the transmission means transmits the transmission information to a second terminal that is communicably connected to the server via the information transmission means, and is available to the supporter. In addition, in this support method, the server determines whether the first information includes introducer information relating to an introducer of the support recipient, the introducer having a predetermined attribute, and distinguishes between a first support recipient having the first information including the introducer information and a second support recipient having the first information not including the introducer information, in the transmission information generation process, in a case where the first information includes the introducer information relating to the introducer having the predetermined attribute, the transmission information that includes the first information including an indication or sound that distinguishes between the first support recipient including the introducer information and the second support recipient not including the introducer information, only the first information relating to the first support recipient, or only the first information relating to the second support recipient, is generated, and in the information transmission process, the transmission information that includes the first information including the indication or the sound that distinguishes between the first support recipient including the introducer information and the second support recipient not including the introducer information, only the first information relating to the first support recipient, or only the first information relating to the second support recipient, is transmitted to the second terminal.

According to each of the support methods described above, a support recipient that has been introduced by an introducer having a predetermined attribute (the first support recipient) can be distinguished from a support recipient that has not been introduced (the second support recipient). Specifically, the second terminal can display the first information including the indication or the sound that distinguishes between the first support recipient including the introducer information and the second support recipient not including the introducer information, only the first information relating to the first support recipient, or only the first information relating to the second support recipient, and therefore the supporter of the second terminal can recognize the first support recipient and the second support recipient in a mutually distinguished manner. This can make it easy to determine the “priority order” when the supporter provides support. As a result, the supporter can reduce a time or mental work burden of giving the “priority order”, and therefore the supporter can focus time and effort on achieving further enhanced support to the support recipient.

Note that, in all of the inventions described above, a fact that the “introducer having the predetermined attribute” is at least one selected from a group of a financial institution (including a city bank, a regional bank, a trust bank, a second-tier regional bank, the Norinchukin Bank, an agricultural cooperative, the Federation of Agricultural Cooperatives, a credit union, a credit association, a labor bank, JAPAN POST BANK Co., Ltd., and a securities company), a chamber of commerce and industry, a commercial and industrial association, a government office, a local government, a junior chamber, a public incorporated foundation, a public incorporated association, an incorporated administrative agency, a life insurance company, a non-life insurance company, an agricultural cooperative (JA), a hospital, a doctor, a dentist, a pharmacist, a patent attorney, a lawyer, a certified public accountant, a judicial scrivener, a tax accountant, a small and medium enterprise management consultant, a real estate appraiser, a public consultant on social and labor insurance, an administrative scrivener, a land and house investigator, a maritime procedure agent, an architect, a technical college, a national university corporation, a public university corporation, and an incorporated educational institution indicates the evidence that the support recipient has obtained certain trust from the institution, juridical person, or organization described above, or an individual, and therefore the supporter can support the support recipient with security.

Note that from among the examples described above of the “introducer having the predetermined attribute”, in particular, a financial institution, a certified public accountant, and a tax accountant are highly likely to know the financial condition (for example, a statement of accounts) of the support recipient, and therefore the supporter can reliably obtain a reward after supporting the support recipient, and the supporter can support the recipient with more security.

### Effects of the Invention

According to a support system in one aspect of the present invention or a support method in one aspect of the present invention, it is possible to easily determine a “priority order” when a supporter provides support. As a result, the supporter can reduce a time or mental work burden of giving the “priority order”, and therefore the supporter can focus time and effort on achieving further enhanced support to the support recipient.

### BRIEF DESCRIPTION OF THE DRAWINGS

FIG. 1 is a diagram illustrating a schematic configuration of a support system according to a first embodiment.

FIG. 2 is a flowchart that explains each process in an example in which the support system according to the first embodiment is used.

FIG. 3 is a diagram in which Display Examples (1) to (7) in which a first support recipient and a second support recipient are displayed in a mutually distinguished manner in a display unit that is connected to a server of the support system according to the first embodiment and/or a second terminal that is available to a supporter are compared with a conventional example in which the first support recipient and the second support recipient are displayed in a non-distinguished manner.

FIG. 4 is a flowchart that explains each process in another example in which the support system according to the first embodiment is used.

FIG. 5 is a diagram illustrating a schematic configuration of a support system according to a second embodiment.

### EMBODIMENTS OF THE INVENTION

Next, embodiments of the present invention will be described in detail with reference to the accompanying drawings. In this description, common portions are denoted by common reference signs in all of the drawings, unless otherwise specified. In addition, in the drawings, elements in the present embodiments are not necessarily illustrated according to the scale. Furthermore, in order to make each of the drawings easily viewable, some reference signs can be omitted.

### First Embodiment

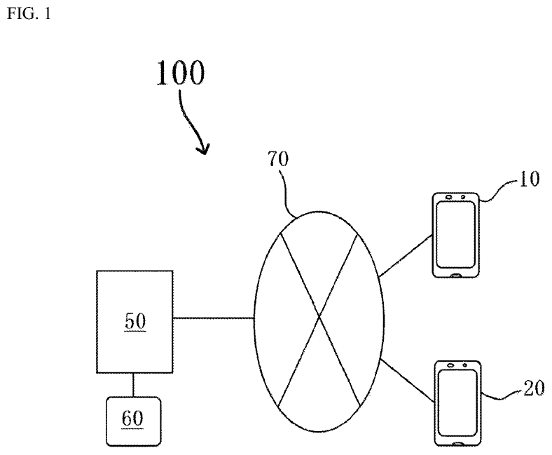

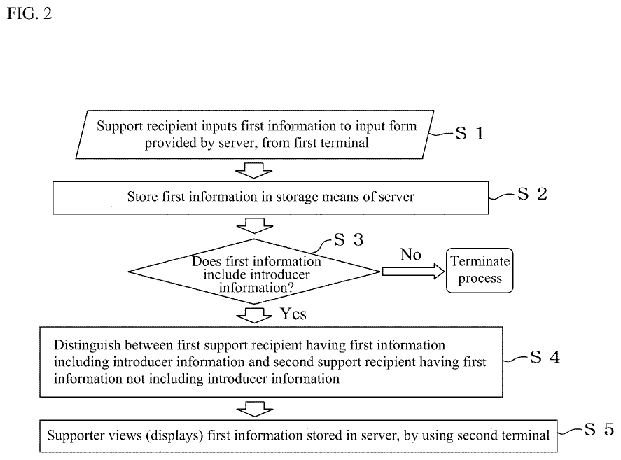

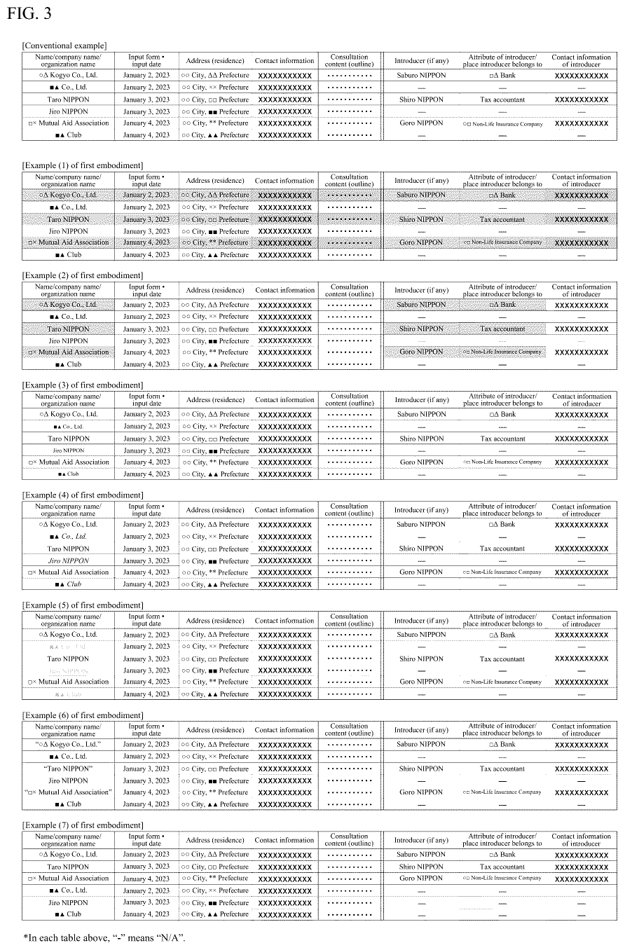

FIG. 1 is a diagram illustrating a schematic configuration of a support system 100 according to the present embodiment. FIG. 2 is a flowchart that explains each process in an example in which the support system 100 according to the present embodiment is used. FIG. 3 is a diagram in which display examples (Examples (1) to (7) of the first embodiment) in which a first support recipient and a second support recipient are displayed in a mutually distinguished manner in a display unit that is connected to a server of the support system according to the present embodiment and/or a second terminal that is available to a supporter, are compared with a conventional example in which the first support recipient and the second support recipient are displayed in a non-distinguished manner.

As illustrated in FIG. 1, in the support system 100 according to the present embodiment, a first terminal 10 to which first information is input by a support recipient who requests support from a supporter, the support recipient being one selected from a group of a natural person, a juridical person, and an organization without juridical personality, a second terminal 20 that is available to the supporter, and a server 50 that includes storage means for storing first information (possibly including information other than the first information), or includes the storage means and transmission means for transmitting the first information (possibly including information other than the first information) are communicably connected via information transmission means 70 represented by the Internet.

More specifically, the first terminal 10 is a terminal that is communicably connected to the server 50 via the information transmission means 70, is available to the support recipient, and enables the first information to be input to an input form provided by the server 50. In addition, the second terminal 20 is a terminal that is communicably connected to the server 50 via the information transmission means 70, is available to the supporter, and enables the first information stored by the storage means of the server 50 by using the information transmission means 70 to be viewed or is capable of receiving the first information transmitted by the transmission means of the server 50. Examples of the first terminal 10 and the second terminal 20 are commercially available mobile terminals (typically, mobile phones, smartphones, tablets, or personal computers having a display function, a communication and call function (including a sound generation function), and a storage function). In addition, the server 50 stores the first information in a storage area (an example of the storage means) that is included in the server 50 or is connected to the server 50. Note that the server 50 is not limited to one installed on the premises of a facility that is administered by a user of the server 50, and may be a cloud server.

Here, the first information in the present embodiment can include information relating to an attribute of the support recipient, and information relating to a background of a request for support. As a specific example, the first information can include a name (in the case of an individual), a company name (in the case of a juridical person), an organization name (in the case of an organization without juridical personality), an address or a residence, a contact information (including a telephone number, an email address, an account of a social networking service (SNS), an account of a short message service (SMS), and an address of a multimedia messaging service(MMS)), and an outline of consultation content (the content of a request for support). In addition, the first information in the present embodiment can include, as an example of the information relating to a background of a request for support, information relating to an introducer (including a natural person, a juridical person, and an organization without juridical personality) who introduces a support recipient to a supporter (hereinafter also referred to as “introducer information”), in addition to the respective pieces of information described above. Examples of the introducer information in the present embodiment can include a name of the introducer, an attribute of the introducer (including a company that the introducer belongs to, a position at the company, or a qualification (in the case of professionals or the like)), and a contact information of the introducer. The specific examples described above are not to be construed as limiting, and other information can be included in the first information.

Note that, in the present embodiment, it is allowable that the first information does not include some of the examples described above of information. Therefore, for example, there is a possibility that a support recipient who only requests a meeting performed by using an information communication system does not input information relating to “address or residence”, but such an example of the first information is also another aspect that is adoptable in the present embodiment. In addition, as illustrated in FIG. 3 described later, a case where the introducer information has not been input (stated another way, the introducer information is not included) is also treated as the first information.

Next, each process in an example in which the support system 100 is used will be described with reference to FIG. 2. Note that the server 50 including a central processing unit (CPU) monitors or integrally controls each of the processes illustrated in FIG. 2 by executing a program for performing each of the processes illustrated in FIG. 2. In the present embodiment, the program can be stored in the storage means (for example, a publicly known hard disk drive) of the server 50 or a publicly known recording medium such as an optical disk to be inserted into an optical disk drive provided in the server 50, but a storage destination of the program is not limited thereto. For example, a portion or the entirety of the program can also monitor or control the processes illustrated in FIG. 2 by using a publicly known technique such as a local area network or an Internet line.

In the present embodiment, the first information is input to an input form provided by the server 50 by the support recipient who uses the first terminal 10 (step S1: an input process). Note that a format of the input form is not limited as long as the input form is a form that the content described in the table illustrated in FIG. 3 can be input to. In addition, a means by which the server 50 provides the input form is not limited. For example, in a representative adoptable aspect, the first terminal 10 establishes connection to the input form stored by the storage means of the server 50 via the information transmission means 70 to input the first information to the input form.

Thereafter, the first information is stored in the storage means (for example, a publicly known hard disk drive or a publicly known cloud storage) of the server 50 (step S2: a storage process).

Thereafter, in the support system 100 and a support method according to the present embodiment, for example, the server 50 performs a determination process of determining whether the first information stored by the server 50 includes the introducer information (step S3).

In a case where some of the pieces of first information of a plurality of support recipients include the introducer information, a process of distinguishing between a support recipient having first information including the introducer information (hereinafter also referred to as a “first support recipient”) and a support recipient having first information not including the introducer information (hereinafter also referred to as a “second support recipient”) is performed (step S4).

Then, in the support system 100 and the support method according to the present embodiment, a display process of displaying pieces of first information that have been stored by the server 50 and have been distinguished in step S4 described above in the second terminal 20 of the supporter that is connected to the server 50, is performed (step S5). Therefore, the supporter who uses the second terminal 20 views the pieces of first information that have been stored by the storage means of the server 50 and have been distinguished in step S4 described above, by using the information transmission means 70. Therefore, even if the first information is not transmitted to the second terminal 20 by the transmission means of the server 50 or another transmission means, the second terminal 20 can view the pieces of first information that have been distinguished by the server 50. On the other hand, the supporter who uses the second terminal 20 uses the transmission means of the server 50 to receive the pieces of first information, and therefore the first support recipient and the second support recipient can also be displayed in a mutually distinguished manner in the second terminal 20.

As described above, by using the support system 100 and the support method according to the present embodiment, the first support recipient and the second support recipient are displayed in a mutually distinguished manner. Examples illustrated as Examples (1) to (7) of the first embodiment in FIG. 3 are specific display examples. Characteristics of display content in a case where the support system 100 according to the present embodiment is employed will be described below focusing on a difference from the display content of a “conventional example” illustrated in FIG. 3.

In a table in the conventional example (an example to which the present embodiment has not been applied) of FIG. 3, a display is conducted in order of earliness of date when the first information has been input by the support recipient, from the top. In this case, distinguishment has not been performed on a display according to the presence or absence of the introducer information, and therefore the supporter normally considers providing support from the top (that is, in order of earliness).

On the other hand, in Example (1) of the first embodiment illustrated in FIG. 3, the background color (hereinafter also referred to as a “first background color”) of only first information including the introducer information (namely, pieces of first information of ○Δ Kogyo Co., Ltd., Taro NIPPON, and □×Mutual Aid Association) is made different from the background color (hereinafter also referred to as a “second background color”) of the other first information (namely, pieces of first information of ▪▴ Co., Ltd., Jiro NIPPON, and ▪▴ Club), over the entirety of the first information. In this case, distinguishment has been performed on a display according to the presence or absence of the introducer information, and therefore the supporter can consider providing support, by using the presence or absence of the introducer information as a determination criterion. As a result, as illustrated as Example (1), even when six requests have been received in three days, Jan. 2 to 4, 2023, it is possible to achieve a reduction in a work burden of giving a “priority order”, which is very troublesome for supporters (typically, experts). Note that this example indicates an example of a relatively small number of requests, six consultation requests in 3 days. However, if this period is extended to about several days to two weeks, or if the number of consultations exceeds 100, there may be a possibility that the supporter will go beyond the limit of the processing capacity. However, by employing the support system 100 according to the present embodiment, it is possible to reliably achieve a reduction in a work burden of giving a “priority order” of support.

Here, in Example (1) of the first embodiment, examples of a predetermined attribute of the introducer information that can be included in the first information include □Δ Bank, a tax accountant, and ○□ Non-Life Insurance Co., Ltd., but a target of the “predetermined attribute” is not limited to the examples described above. For example, in an adoptable aspect, a user or an administrator of the server 50 determines the “predetermined attribute” in advance, and in another adoptable aspect, the supporter freely determines the “predetermined attribute” in advance.

Note that a fact that the “predetermined attribute” included in the introducer information is at least one selected from a group of a financial institution (including a city bank, a regional bank, a trust bank, a second-tier regional bank, the Norinchukin Bank, an agricultural cooperative, the Federation of Agricultural Cooperatives, a credit union, a credit association, a labor bank, JAPAN POST BANK Co., Ltd., and a securities company.), a chamber of commerce and industry, a commercial and industrial association, a government office, a local government, a junior chamber, a public incorporated foundation, a public incorporated association, an incorporated administrative agency, a life insurance company, a non-life insurance company, an agricultural cooperative (JA), a hospital, a doctor, a dentist, a pharmacist, a patent attorney, a lawyer, a certified public accountant, a judicial scrivener, a tax accountant, a small and medium enterprise management consultant, a real estate appraiser, a public consultant on social and labor insurance, an administrative scrivener, a land and house investigator, a maritime procedure agent, an architect, a technical college, a national university corporation, a public university corporation, and an incorporated educational institution indicates the evidence that the support recipient (the first support recipient) introduced by each introducer has obtained certain trust from the institution, juridical person, or organization described above, or an individual, and therefore the supporter can support the support recipient with security.

In addition, in Example (1) of the first embodiment, each of the introducers of ○Δ Kogyo Co., Ltd. and Taro NIPPON is one selected from a group of a financial institution, a certified public accountant, and a tax accountant, and therefore it is highly likely that the introducer knows the financial condition (for example, a statement of accounts) of the support recipient (the first support recipient). Thus, the supporter can reliably obtain a reward after supporting the support recipient, and the supporter can support the recipient with more security.

On the other hand, there is also a determination criterion by which the supporter determines that the presence of an introducer is not favorable. Even in such a case, the supporter can consider providing support by using the presence or absence of the introducer information as a determination criterion. As a result, as illustrated as Example (1) of the first embodiment, even when six requests have been received in three days, Jan. 2 to 4, 2023, it is possible to achieve a reduction in a work burden of giving the “priority order”, which is very troublesome for supporters (typically, experts).

Next, in Example (2) of the first embodiment illustrated in FIG. 3, a portion of the first background color of only the first information including the introducer information (namely, pieces of first information of ○Δ Kogyo Co., Ltd., Taro NIPPON, and □×Mutual Aid Association) is made different from the second background color of the other first information, in this example, respective corresponding characters. In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts).

Next, in Example (3) of the first embodiment illustrated in FIG. 3, a size of characters (hereinafter also referred to as “first characters”) of the first information including the introducer information (namely, pieces of first information of ○Δ Kogyo Co., Ltd., Taro NIPPON, and □×Mutual Aid Association) is made different from a size of characters (hereinafter also referred to as “second characters”) of the other first information. In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts).

Next, in Example (4) of the first embodiment illustrated in FIG. 3, characters of only the first information not including the introducer information (namely, pieces of first information of ▪▴ Co., Ltd., Jiro NIPPON, and ▪▴ Club) are written in italics, and are made different from characters of the first information including the introducer information (namely, pieces of first information of ○Δ Kogyo Co., Ltd., Taro NIPPON, and □×Mutual Aid Association). In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts).

Next, in Example (5) of the first embodiment illustrated in FIG. 3, characters (second characters) of only the first information not including the introducer information (namely, pieces of first information of ▪▴ Co., Ltd., Jiro NIPPON, and ▪▴ Club) are displayed in a gray-out state, and are made different from characters (first characters) of the first information including the introducer information (namely, pieces of first information of ○Δ Kogyo Co., Ltd., Taro NIPPON, and □×Mutual Aid Association). In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts). Note that, in Example (5), the first characters may be characters that are displayed in a gray-out state, and the second characters may be characters that are not displayed in a gray-out state, in contrast to the description above.

Next, in Example (6) of the first embodiment illustrated in FIG. 3, only the first information including the introducer information (namely, pieces of first information of ○Δ Kogyo Co., Ltd., Taro NIPPON, and □×Mutual Aid Association) is displayed in a blinking manner, and is made different from the background color of the other first information. In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts).

Next, in Example (7) of the first embodiment illustrated in FIG. 3, distinguishment has been performed by collecting pieces of first information including the introducer information (namely, pieces of first information of ○Δ Kogyo Co., Ltd., Taro NIPPON, and □×Mutual Aid Association) in an upper position (in this example, an uppermost row to a third row) in the table, and collecting pieces of other first information in a lower position (in this example, a fourth row to a lowermost row). In this case, similarly to Example (1) of the first embodiment, distinguishment has been performed on a display according to the presence or absence of the introducer information, and therefore the supporter can consider providing support, by using the presence or absence of the introducer information as a determination criterion. As a result, similarly to Example (1) of the first embodiment, it is possible to achieve a reduction in a work burden of giving the “priority order”, which is very troublesome for supporters (typically, experts).

Note that, in addition to the respective examples described above, in another preferable aspect, “distinguishment” is performed by applying a change in size of a character, a form of a character (including italics, a change in font, and a thick character), an underline, or any combination thereof, and a change in a character to, for example, respective corresponding characters of characters of only first information including the introducer information (namely, pieces of first information of ○Δ Kogyo Co., Ltd., Taro NIPPON, and □×Mutual Aid Association) or characters of only first information not including the introducer information (namely, pieces of first information of ▪▴ Co., Ltd., Jiro NIPPON, and ▪▴ Club).

Furthermore, in addition to the respective examples described above, in another preferable aspect, “distinguishment” is performed by conducting a gray-out display, a blinking display, a display with dotted line characters (a dotted line display), a pop-up display, or a display in a different window (or a screen), or any combination thereof for characters of only first information including the introducer information (namely, pieces of first information of ○Δ Kogyo Co., Ltd., Taro NIPPON, and □×Mutual Aid Association) or characters of only first information not including the introducer information (namely, pieces of first information of ▪▴ Co., Ltd., Jiro NIPPON, or ▪▴ Club).

In addition, in another adoptable aspect, instead of distinguishment using the display described above or in addition to distinguishment using the display described above, the first support recipient and the second support recipient are distinguished by causing a sound generation unit (for example, a speaker) that is included in the server 50 and/or the second terminal 20 to emit different sound. Note that a representative example of the “different sound” described above is at least one selected from a group of the strength of sound, sound including a different language (including sound obtained by exhibiting a publicly known translation function), sound having a different frequency (including a difference between a male voice and a female voice), and the different speed of sound, but these examples are not restrictive.

### Variation (1) of First Embodiment

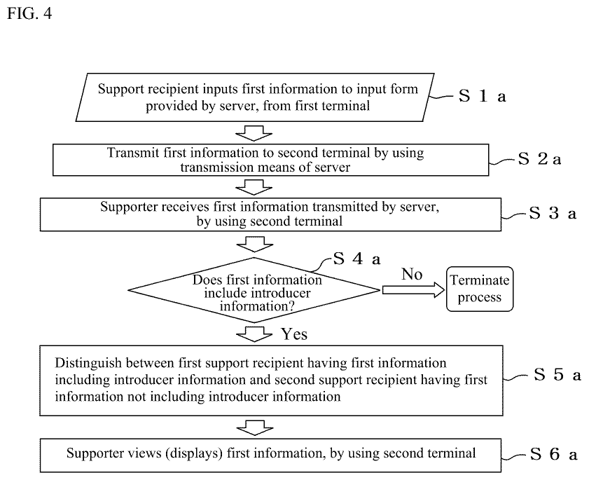

Next, each process of another example (a variation) in which a support system 100 and a support method according to the present variation will be described with reference to FIG. 4. Note that a duplicate description of the first embodiment described above can be omitted.

In the present variation, a support recipient who uses the first terminal 10 inputs the first information to an input form provided by the server 50 (step S1a).

Thereafter, the transmission means of the server 50 transmits the first information to the second terminal 20 available to a supporter, via the information transmission means 70 (step S2a). In the present variation, the first information that has been input to the input form provided by the server 50 can be stored by the storage means of the server 50, but the present variation is not limited to such an example. For example, in another adoptable example, after the input form provided by the server 50 has been downloaded by the first terminal 10 by using the information transmission means, the first information that has been input to the downloaded input form is stored by the storage means that is included in the first terminal 10, and is capable of at least temporarily storing information. In the case of the “another adoptable example”, the first information can be transmitted from the first terminal 10 to the server 50 that is communicably connected via the information transmission means 70, and can also be transmitted to the second terminal 20 by the transmission means of the server 50, and therefore the server 50 does not necessarily need to include storage means for storing the first information.

Thereafter, the first information is received by the second terminal 20 (step S3a). In an adoptable aspect of the present variation, the first information is temporarily or permanently stored by the storage means (for example, a publicly known memory or a publicly known internal storage of a smartphone) of the second terminal 20.

Thereafter, for example, a central processing unit (CPU) included in the second terminal 20 performs a determination process of determining whether the first information received by the second terminal 20 includes the introducer information (step S4a). Note that, in this variation, similarly to the server 50 according to the first embodiment, the second terminal 20 monitors or integrally controls at least some of the respective processes illustrated in FIG. 4 by executing a program for performing at least some of the respective processes illustrated in FIG. 4.

In a case where some of pieces of first information of a plurality of support recipients include the introducer information, the second terminal 20 performs a process of distinguishing between a first support recipient having first information including the introducer information and a second support recipient having first information not including the introducer information (step S5a).

Then, in the support system 100 and the support method according to the present variation, a display process of displaying pieces of first information that have been distinguished in step S4 described above in the second terminal 20 of the supporter, is performed (step S6a). Therefore, the supporter who uses the second terminal 20 can view the pieces of first information that have been distinguished by the second terminal 20, without using the information transmission means 70. In the present variation, after the first information has been received by the second terminal 20, the second terminal 20 does not necessarily need to be connected to the server 50 by using the information transmission means 70 in each of step S4a and the processes that follow.

As described above, in the example illustrated in FIG. 4, similarly, by using the support system 100 and the support method, the first support recipient and the second support recipient are displayed in a mutually distinguished manner. As a result, it is possible to achieve a reduction in a work burden of giving the “priority order”, which is very troublesome for supporters (typically, experts).

### Variation (2) of First Embodiment

In the present variation, as illustrated in FIG. 1, the server 50 can also be connected to the display unit 60. In other words, a support system 100 in the present variation does not necessarily need to include the display unit 60. The display unit 60 is used to display the first information described above (including pieces of first information that have been distinguished in step S4 in the first embodiment). Therefore, in this variation, a user or an administrator who does not have the second terminal 20 or who uses or administers the server 50 that fails to use a display function of the second terminal 20 can view the first information described above, by using the display unit 60.

Note that, in the present variation, similarly to the first embodiment, it is possible to achieve a display that is similar to the display examples illustrated in FIG. 3 (Examples (1) to (7) of the first embodiment) in which the first support recipient and the second support recipient are displayed in a mutually distinguished manner.

### Second Embodiment

A support method according to the present embodiment is a support method that is similar to the support methods according to the first embodiment and the respective variations thereof, excluding a point that after the “input process” (step S1) to the“ distinguishing process” (step S4) in the first embodiment and the respective variations thereof have been performed, a transmission information generation process and an information transmission process are performed instead of the display process (step S5) or together with at least a portion of the display process. Furthermore, a support system 200 according to the present embodiment is a support system that is similar to the support systems according to the first embodiment and the respective variations thereof, excluding a point that a transmission information generation unit 51 that generates transmission information (in the present embodiment, information included in an email) that includes the first information, and an information transmission unit 52 are included. Therefore, a duplicate description of the support system 100 and the support method according to the first embodiment can be omitted.

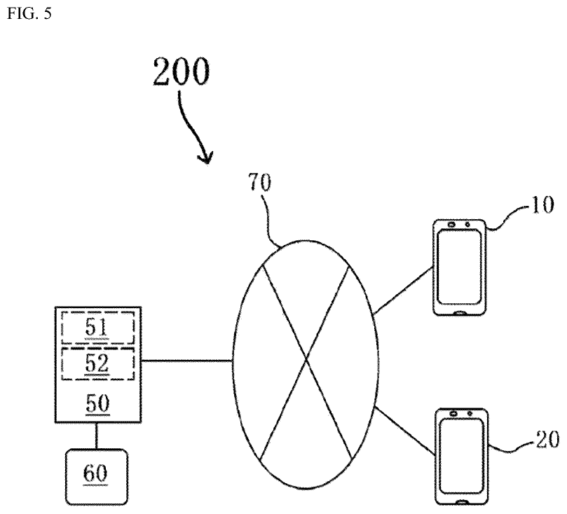

FIG. 5 is a diagram illustrating a schematic configuration of a support system according to the present embodiment.

As described above, the support system 200 includes the transmission information generation unit 51(in the present embodiment, an email information generation unit) that generates transmission information (in the present embodiment, information included in an email) that includes the first information described above, and the information transmission unit 52 (in the present embodiment, typically, an email transmission unit) that is capable of transmitting the transmission information or an email including the transmission information, for example, via the information transmission means 70.

In the present embodiment, after the “distinguishing process” (step S4) in the first embodiment and the respective variations thereof has been performed, in a case where the first information includes introducer information relating to an introducer having a predetermined attribute, the transmission information generation unit 51 generates the transmission information (in the present embodiment, information included in an email) that includes the first information including an indication distinguishing between the first support recipient including the introducer information and the second support recipient not including the introducer information, or only the first information relating to the first support recipient having the first information including the introducer information or only the first information relating to the second support recipient having the first information not including the introducer information (an example of the transmission information generation process). Note that, an example of the transmission information that includes the indication distinguishing between the first support recipient and the second support recipient according to the present embodiment can include an indication that is similar to that in the display examples illustrated in FIG. 3 (Examples (1) to (7) of the first embodiment) in which the first support recipient and the second support recipient are displayed in a mutually distinguished manner.

In addition, after the transmission information generation process described above has been performed, the information transmission unit 52 according to the present embodiment transmits transmission information that includes the first information including an indication distinguishing between the first support recipient including the introducer information and the second support recipient not including the introducer information, or only the first information relating to the first support recipient or only the first information relating to the second support recipient, more specifically, an email including the transmission information, to the second terminal 20 that is available to the supporter, for example, via the information transmission means 70 (an example of the information transmission process). As a result, the second terminal 20 can display the first support recipient including the introducer information and the second support recipient not including the introducer information in a mutually distinguished manner, or can display only the first information relating to the first support recipient or only the first information relating to the second support recipient, and therefore the supporter (a user) of the second terminal 20 can recognize the first support recipient and the second support recipient in a mutually distinguished manner. By employing the support system 200 and the support method according to the present embodiment, similarly to the first embodiment and the respective variations thereof, it is possible to achieve a reduction in a work burden of giving the “priority order”, which is very troublesome for supporters (typically, experts).

In another adoptable aspect, instead of distinguishment using the display described above or in addition to distinguishment using the display described above, for example, a sound generation unit (for example, a speaker) that is included in the server 50 and/or the second terminal 20 and emits sound emits different sound (for example, the strength of sound, sound including a different language (including sound obtained by exhibiting a publicly known translation function), or sound having a different frequency (including a difference between a male voice and a female voice)) to distinguish between the first support recipient and the second support recipient. Here, in a case where the sound is used, the transmission information generation unit 51 generates the transmission information (in the present embodiment, information included in an email) that includes the first information including sound distinguishing between the first support recipient including the introducer information and the second support recipient not including the introducer information, or only the first information relating to the first support recipient having the first information including the introducer information or only the first information relating to the second support recipient having the first information not including the introducer information (an example of the transmission information generation process). In addition, in a case where the sound is used, after the transmission information generation process described above has been performed, the information transmission unit 52 according to the present embodiment transmits transmission information that includes the first information including sound distinguishing between the first support recipient including the introducer information and the second support recipient not including the introducer information, or only the first information relating to the first support recipient or only the first information relating to the second support recipient, more specifically, an email including the transmission information, to the second terminal 20 that is available to the supporter, for example, via the information transmission means 70 (an example of the information transmission process).

Meanwhile, in the present embodiment, the server 50 includes the transmission information generation unit 51 and the information transmission unit 52, but the support system 200 according to the present embodiment is not limited to such a configuration. For example, even in a case where the transmission information generation unit 51 and/or the information transmission unit 52 (including publicly known transmission means) is disposed in a place that is physically separated from the server 50, and is communicably connected to the server 50 in a wired manner or a wireless manner (including the information transmission means 70 represented by the Internet), advantageous effects that are similar to those of the present embodiment can be exhibited.

In addition, in a preferred aspect of each of the embodiments or variations described above, in a case where the first information includes the introducer information, a process in which the server 50 emits different sound while distinguishing between the first support recipient and the second support recipient in a case where the first information includes the introducer information is employed instead of the display process of conducting a display on the display unit that is connected to the server 50 or in addition to the display process.

In addition, in a preferred aspect of each of the embodiments or variations described above, in a case where the first information includes the introducer information, a process in which the second terminal 20 emits different sound by using the information transmission means 70 while distinguishing between the first support recipient and the second support recipient is employed instead of the display process of displaying the first support recipient and the second support recipient that have been distinguished by the server 50, in a mutually distinguished manner in the second terminal 20, by using the information transmission means 70 or together with the display process.

In addition in a case where the first information includes the introducer information, a process in which the second terminal 20 emits different sound while distinguishing between the first support recipient and the second support recipient, without using the information transmission means 70 is employed instead of the display process of displaying the first support recipient and the second support recipient that have been distinguished by the second terminal 20, in a mutually distinguished manner in the second terminal 20, without using the information transmission means 70 or together with the display process.

In addition, in a preferred aspect of each of the embodiments or variations described above, in a case where the first information includes the introducer information, a process in which the second terminal 20 emits different sound while distinguishing between the first support recipient and the second support recipient, by using the transmission means of the server 50 is employed instead of the display process of displaying the first support recipient and the second support recipient in a mutually distinguished manner in the second terminal 20, by using the transmission means of the server 50 or together with the display process.

In addition, in another preferable aspect of a variation of the support system 200 according to the present embodiment, a transmission information generation unit that generates transmission information that includes the first information described above by using a social networking service (SNS), a short message service (SMS), or a multimedia messaging service (MMS) is employed instead of the transmission information generation unit 51 or together with the transmission information generation unit 51. In addition, in another preferable aspect of another variation of the support system 200 according to the present embodiment, an information transmission unit that transmits transmission information that includes the first information described above by using a social networking service (SNS), a short message service (SMS), or a multimedia messaging service (MMS) is employed instead of the information transmission unit 52 or together with the information transmission unit 52.

The disclosure of the respective embodiments and the respective variations thereof that have been described above has been provided to describe the embodiments and the respective variations thereof, and has not been provided to limit the present invention. In addition, variations within the scope of the present invention including other combinations in the respective embodiments and the respective variations thereof that have been described above are also included in the claims.

For example, in another adoptable aspect, in the support system 100 according to the first embodiment, both the means described with reference to FIG. 2 for displaying the first support recipient and the second support recipient in a mutually distinguished manner and the means described with reference to FIG. 4 for displaying the first support recipient and the second support recipient in a mutually distinguished manner are used.

In addition, in another adoptable aspect, the technical idea disclosed in the “SOLUTIONS TO THE PROBLEMS” of the description of the present application, the first embodiment, or the respective variations thereof is introduced into the support system 200 or the support method according to the second embodiment. For example, although partially described in a duplicate manner, at least some of the advantageous effects disclosed in the “SOLUTIONS TO THE PROBLEMS” of the description of the present application, the first embodiment, or the respective variations thereof can be exhibited by employing the fact that the first information described in the first embodiment can include the introducer information and/or a process of distinguishing a support recipient (the first support recipient) who has been introduced by an introducer having the “predetermined attribute” described in the first embodiment from a support recipient (the second support recipient) who has not been introduced, as already described above. In addition, in another adoptable aspect, at least a portion of the technical idea disclosed in Examples (1) to (7) of the first embodiment illustrated in FIG. 3 is introduced into the support system 200 or the support method according to the second embodiment.

### Industrial Applicability

A support system and a support method of the present invention can be widely used as a system and a method that are capable of achieving a reduction in a work burden when a supporter who has received a plurality of consultation requests simultaneously or during the same period gives a priority order.

### DESCRIPTION OF REFERENCE SIGNS

10: First terminal
20: Second terminal
50: Server
51: Transmission information generation unit
52: Information transmission unit
60: Display unit
70: Information transmission means
100, 200: Support system

1. A support system comprising:
a server that includes storage means for storing first information relating to a support recipient who requests support from a supporter, or includes the storage means and transmission means for transmitting the first information, the support recipient being one selected from a group of a natural person, a juridical person, and an organization without juridical personality;
a transmission information generation unit that generates transmission information that includes the first information; and
an information transmission unit that is capable of transmitting the transmission information, wherein
when the first information has been input to an input form provided by the server, from a first terminal that is communicably connected to the server via information transmission means, and is available to the support recipient, the support system enters into a state (a) or (b) described below:
(a) a state in which transmission information that includes the first information is stored by the storage means of the server, and the first information that has been stored by the storage means by using the information transmission means is viewable by using a second terminal that is communicably connected to the server via the information transmission means, and is available to the supporter; and
(b) a state in which the first information that has been transmitted by the transmission means of the server is viewable by using the second terminal that is capable of receiving the first information,
in a case where the first information includes introducer information relating to an introducer having a predetermined attribute, the transmission information generation unit generates the transmission information that includes the first information including an indication or sound that distinguishes between a first support recipient including the introducer information and a second support recipient not including the introducer information, only the first information relating to the first support recipient having the first information including the introducer information, or only the first information relating to the second support recipient having the first information not including the introducer information, and
the information transmission unit transmits, to the second terminal, the transmission information that includes the first information including the indication or the sound that distinguishes between the first support recipient including the introducer information and the second support recipient not including the introducer information, only the first information relating to the first support recipient, or only the first information relating to the second support recipient.

2. The support system according to claim 1, wherein
the introducer having the predetermined attribute is at least one selected from a group of a financial institution, a chamber of commerce and industry, a commercial and industrial association, a government office, a local government, a junior chamber, a public incorporated foundation, a public incorporated association, an incorporated administrative agency, a life insurance company, a non-life insurance company, an agricultural cooperative (JA), a hospital, a doctor, a dentist, a pharmacist, a patent attorney, a lawyer, a certified public accountant, a judicial scrivener, a tax accountant, a small and medium enterprise management consultant, a real estate appraiser, a public consultant on social and labor insurance, an administrative scrivener, a land and house investigator, a maritime procedure agent, an architect, a technical college, a national university corporation, a public university corporation, and an incorporated educational institution.

3. A support method performed by using a support system including a server that includes storage means for storing first information relating to a support recipient who requests support from a supporter, or includes the storage means and transmission means for transmitting the first information, the support recipient being one selected from a group of a natural person, a juridical person, and an organization without juridical personality, the support method comprising respective processes including (a), (b), and (c1) described below, respective processes including (a), (b), and (c2), respective processes including (a), (b), and (c3), or respective processes including (a), (b), and (c4):
(a) a determination process in which, when the first information has been input to an input form provided by the server, from a first terminal that is communicably connected to the server via information transmission means, and is available to the support recipient,
the server that has stored the first information, or
a second terminal that is communicably connected to the server via the information transmission means, is available to the supporter, and enables the first information that has been stored by the storage means of the server by using the information transmission means to be viewed or is capable of receiving and storing the first information that has been transmitted by the transmission means performs
determining whether the first information includes introducer information relating to an introducer of the support recipient, the introducer having a predetermined attribute;
(b) a process in which the server or the second terminal distinguishes between a first support recipient having the first information including the introducer information and a second support recipient having the first information not including the introducer information;
(c1) a display process in which, in a case where the first information includes the introducer information, the first support recipient and the second support recipient are displayed in a mutually distinguished manner in a display unit that is connected to the server, or a process in which, in a case where the first information includes the introducer information, the server emits different sound while distinguishing between the first support recipient and the second support recipient;
(c2) a display process in which, in a case where the first information includes the introducer information, the first support recipient and the second support recipient that have been distinguished by the server are displayed in the mutually distinguished manner in the second terminal, by using the information transmission means, or a process in which, in a case where the first information includes the introducer information, the second terminal emits the different sound while distinguishing between the first support recipient and the second support recipient, by using the information transmission means;
(c3) a display process in which, in a case where the first information includes the introducer information, the first support recipient and the second support recipient that have been distinguished by the second terminal are displayed in the mutually distinguished manner in the second terminal, without using the information transmission means, or a process in which, in a case where the first information includes the introducer information, the second terminal emits the different sound while distinguishing between the first support recipient and the second support recipient, without using the information transmission means; and
(c4) a display process in which, in a case where the first information includes the introducer information, the first support recipient and the second support recipient are displayed in the mutually distinguished manner in the second terminal, by using the transmission means of the server, or a process in which, in a case where the first information includes the introducer information, the second terminal emits the different sound while distinguishing between the first support recipient and the second support recipient, by using the transmission means of the server.

4. A support method performed by a support system including a server that includes storage means for storing first information relating to a support recipient who requests support from a supporter, and transmission means for transmitting the first information, the support recipient being one selected from a group of a natural person, a juridical person, and an organization without juridical personality, the support method comprising:
a transmission information generation process of generating transmission information that includes the first information, when the first information has been input to an input form provided by the server, from a first terminal that is communicably connected to the server via information transmission means, and is available to the support recipient; and
an information transmission process of transmitting the transmission information to a second terminal, by using the transmission means, the second terminal being communicably connected to the server via the information transmission means, and being available to the supporter, wherein
the server determines whether the first information includes introducer information relating to an introducer of the support recipient, the introducer having a predetermined attribute, and distinguishes between a first support recipient having the first information including the introducer information and a second support recipient having the first information not including the introducer information,
in the transmission information generation process, in a case where the first information includes the introducer information relating to the introducer having the predetermined attribute, the transmission information that includes the first information including an indication or sound that distinguishes between the first support recipient including the introducer information and the second support recipient not including the introducer information, only the first information relating to the first support recipient, or only the first information relating to the second support recipient, is generated, and
in the information transmission process, the transmission information that includes the first information including the indication or the sound that distinguishes between the first support recipient including the introducer information and the second support recipient not including the introducer information, only the first information relating to the first support recipient, or only the first information relating to the second support recipient, is transmitted to the second terminal.
